(19) United States
(12) Patent Application Publication
(10) Pub. No.: US 2026/0356041 A1
(43) Pub. Date: Nov. 12, 2026

(54) PRECISION MATERIAL DEPOSITION APPARATUS FOR VISCOUS MATERIALS

(71) Applicant: Raven Space Systems, Inc., Broomfield, CO (US)

(72) Inventors: Blake Herren, Denver, CO (US); James DeMarco, Westminster, CO (US); Ryan Cowdrey, Kansas City, MO (US); David Evinshteyn, Boulder, CO (US)

(73) Assignee: Raven Space Systems, Inc., Broomfield, CO (US)

(21) Appl. No.: 19/672,944

(22) Filed: May 11, 2026

Related U.S. Application Data
(60) Provisional application No. 63/803,301, filed on May 9, 2025.

(51) Int. Cl. B29C 64/336; B29C 48/02; B29C 48/475; B29C 48/49; B29C 48/86; B29C 64/118; B29C 64/209; B33Y 30/00; B33Y 50/02

(52) U.S. Cl. CPC B29C 64/336; B29C 48/02; B29C 48/475; B29C 48/49; B29C 48/865; B29C 64/118; B29C 64/209; B33Y 30/00; B33Y 50/02

(57) ABSTRACT

A material deposition apparatus for printing one or more viscous deposition materials. The material deposition apparatus can include a piston and cylinder fed by one or more material reservoirs. Material can be drawn from the reservoir into a cylinder, where it is pushed by the piston out of the nozzle at a controlled rate. Multiple pistons and cylinders can be operated at alternate strokes so that one is extruding while the other is refilling, thus enabling continuous extrusion. One or more valves can be opened and closed to control the flow into and out of the cylinders.

### CROSS-REFERENCE TO RELATED APPLICATIONS

This application claims priority to and the benefit of the filing of U.S. Provisional Patent Application No. 63/803,301, entitled “Precision Extruder for High Viscosity Materials”, filed on May 9, 2025, and the specification thereof is incorporated herein by reference.

### BACKGROUND OF THE INVENTION

### Field of the Invention (Technical Field)

Embodiments of the present invention relate to the precise deposition of materials, which can include for example viscous and/or highly viscous materials for 3D printing, extrusion processes, or pumping applications.

### Description of Related Art

The field of additive manufacturing and 3D printing has rapidly advanced in recent years, leading to the creation of complex geometries and customized products across various industries. Existing polymer 3D printers focus on the extrusion or laser sintering of thermoplastic materials or the use of photopolymerization techniques. However, many applications require the controlled deposition of viscous materials, for example, pastes, gels, and slurries, which present unique challenges not addressed by conventional systems.

Viscous materials are used in a wide range of industries, including composite manufacturing, aerospace, defense, food processing, construction, electronics, pharmaceuticals, direct ink write (“DIW”), microwave assisted deposition (“MAD”), and bioprinting. Existing 3D printers for viscous materials often face limitations in terms of precision, consistency, and material compatibility. The high viscosity of these materials poses significant challenges for pumping, extrusion, and layer deposition. Furthermore, controlling the flow rate and maintaining the structural integrity of the deposited material are critical for achieving high-quality prints. Current solutions frequently lack the versatility to handle a wide range of viscosities, leading to poor performance and restricted applications. Existing printers tend to push on a large amount of material which makes it impossible to control-especially for compressible materials.

There is a present need for a material deposition apparatus and deposition method that can emplace or otherwise deposit viscous materials with high precision, adaptability, and scalability. Such a system needs to manage material flow, maintain consistent deposition, and accommodate diverse material properties.

### BRIEF SUMMARY OF EMBODIMENTS OF THE PRESENT INVENTION

Embodiments of the present invention preferably provide a material deposition apparatus with a piston/cylinder or other displacement apparatus for precise deposition control and the ability for it to be refilled during extrusion to allow for continuous deposition of materials. Embodiments of the present invention can provide a material deposition apparatus with the ability to operate with high viscosity liquid, paste, or gel (for example (“e.g.”) one-part thermosets, two-part thermosets, aqueous ceramics, composites, combinations thereof and the like) at room temperature or an elevated temperature and maintain a controlled temperature during extrusion.

Embodiments of the present invention relate to a material deposition apparatus having a first deposition material container, a first cylinder communicably coupled to the first deposition material container via a first fluid flow path, the first fluid flow path extending from at least the first deposition material container to at least the first cylinder, a first piston disposed at least partially within the first cylinder, the first piston configured to exert a force upon a first deposition material when the first deposition material is disposed within the first cylinder; a first valve capable of being selectively arranged into a first valve open position, and a first valve closed position, the first valve disposed such that when arranged into the first valve closed position, a first flow of fluid from the first deposition material container to the first cylinder is impeded or blocked, and a nozzle. The material deposition apparatus further including a first actuator communicably coupled to the first piston. The first valve can be operated independently from actuation of the first piston. The material deposition apparatus can also have a second cylinder, a second piston and a second valve-the second valve can be capable of being selectively arranged into a second valve open position, and a second valve closed position. The material deposition apparatus can optionally include a second nozzle. The second valve can be disposed such that when the second valve is arranged into the second valve closed position, a second flow of fluid from the first deposition material container to the second cylinder can be impeded or blocked. The material deposition apparatus can include a second deposition material container. The second valve can be disposed such that when the second valve is arranged into the second valve closed position, a flow of fluid from the second deposition material container to the second cylinder can be impeded or blocked.

In one embodiment, the material deposition apparatus can have a third valve disposed between an outlet of the first cylinder and the nozzle. The material deposition apparatus can also have a fourth valve disposed between an outlet of the second cylinder and the nozzle. The material deposition apparatus can be configured such that when the first valve is in the first valve open position, the second valve is in the second valve closed position and wherein when the first valve is in the first valve closed position, the second valve is in the second valve open position. The material deposition apparatus can be configured such that when the first piston is being retracted, the first cylinder is filled with the first deposition material while the second piston is simultaneously being advanced and the second cylinder conveys the first deposition material or another deposition materials. The material deposition apparatus wherein the nozzle is communicably coupled to an outlet of the first cylinder and an outlet of the second cylinder. The material deposition apparatus can also have a second deposition material container and the material deposition apparatus can be configured to allow the first cylinder and the second cylinder to selectively be refilled from either the first deposition material container or the second deposition material container.

In one embodiment, the material deposition apparatus can have a headspace within the first deposition material container that is filled with a pressurized fluid. The first valve can have a plurality of flow paths on a rotatable member such that any of the plurality of flow paths are selectable and/or such that none of the plurality of flow paths are also selectable. The material deposition apparatus can have a compactor positioned and configured to provide compaction of the first deposition material after exiting the nozzle. Optionally, the material deposition apparatus can also have an inductive field generator positioned and configured to heat the first deposition material when the first deposition material is in the nozzle and/or after the first deposition material has exited the nozzle.

Embodiments of the present invention also relate to material deposition apparatus that further has a controller and at least one sensor positioned to sense a quality and/or characteristic of the first deposition material after it has exited the nozzle, the controller communicably coupled to receive data of or relating to the at least one sensor and the controller can be configured to adjust an operating parameter of the material deposition apparatus based upon the received data. One or more heaters can be positioned to conductively heat the first deposition material at one or more locations. The material deposition apparatus can also have a vibrator positioned to communicably impart a vibrational motion to the first deposition material at one or more locations.

Embodiments of the present invention also relate to a material deposition method that includes reciprocating a first plunger at least partially within a first cylinder and toggling a first valve between an open position and closed position with respect to the first cylinder such that when the first valve is toggled to the open position, deposition fluid is allowed to fill the first cylinder as the first piston is being retracted, and subsequently toggling the first valve to a closed position with respect to the first cylinder such that the deposition material no longer flows into the first cylinder, and wherein the deposition material is forced out of the first cylinder as the first piston is advanced within the first cylinder. The method can also include allowing the deposition material that has been forced out of the first cylinder to flow through a nozzle for deposition.

In one embodiment, the method can also include controlling a flow of the deposition material from the first cylinder to the nozzle by selectively toggling a second valve that is in fluid communication between the first cylinder and the nozzle. Optionally, the method can include reciprocating a second plunger at least partially within a second cylinder and allowing deposition material to fill the second cylinder as the second piston is retracted within the second cylinder; and allowing deposition material to be conveyed from the second cylinder and to flow through a different nozzle. The method can also include reciprocating a second plunger at least partially within a second cylinder and allowing deposition material to fill the second cylinder as the second piston is retracted within the second cylinder; and allowing deposition material to be conveyed from the second cylinder and to flow through the nozzle. Optionally, a stroke of the first piston and a stroke of the second piston can be synchronized such that as the first piston is retracted in the first cylinder, the second piston is advanced in the second cylinder. The first valve can be coupled to selectively control a flow of the deposition material from a first deposition material container to each of the first cylinder and the second cylinder. The method can also include vibrating the first deposition material and/or compacting the first deposition material after it has been deposited at a desired application site. The method can also include heating the first deposition material, which can optionally include heating the first deposition material with an inductive heater, wherein the heating occurs while the first deposition material is disposed within a nozzle and/or after the first deposition material has been deposited at an application site. The method can also include monitoring a quality and/or characteristic of the first deposition material after it has been deposited at an application site and automatically adjusting an operating parameter of a deposition apparatus in response to the quality and/or characteristic.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A and 1B are drawings that respectively illustrate a material deposition apparatus while extruding (FIG. 1A) and refilling (FIG. 1B), according to an embodiment of the present invention;

FIG. 1C is a drawing that illustrates a material deposition apparatus having a tamper/compactor for the deposition material as well as illustrating a plurality of locations about which one or more heaters can be provided to heat deposition material;

FIG. 2A, is a drawing which illustrates an embodiment of the present invention wherein a pair of cylinders together share a single supply container and a single nozzle and wherein a plurality of valves are provided to allow switching between the container and the nozzle for each of the two cylinders

FIG. 2B, and 2C are drawings that respectively illustrate a material deposition apparatus wherein both cylinders are coupled to a single nozzle (FIG. 2B), wherein each of the two cylinders has a respective nozzle such that they do not share the same nozzle (FIG. 2C), according to embodiments of the present invention;

FIGS. 3A, 3B, and 3C are drawings which illustrate a material deposition apparatus with a diverting valve in a first state such that deposition material can flow from a left cylinder (FIG. 3A), a second state such that deposition material can flow from a right cylinder (FIG. 3B), and in a third (or intermediary) state such that no deposition material is able to flow from either cylinder (FIG. 3C), respectively, according to an embodiment of the present invention;

FIG. 4 is a drawing that illustrates a material deposition apparatus with two containers and a single deposition material, according to an embodiment of the present invention;

FIGS. 5A, 5B, and 5C are drawings that illustrate a material deposition apparatus with two containers and two deposition materials such that a dedicated container is provided for each cylinder (FIG. 5A), four containers and two deposition materials such that two containers and materials are provided for each respective cylinder (FIG. 5B), and two containers with two deposition materials with interconnections and valves provided such that the two cylinders can both selectively share the deposition material from both containers (FIG. 5C);

FIG. 6 is a drawing that illustrates an embodiment of the present invention wherein a series of material deposition apparatuses are coupled together;

FIG. 7 is a drawing that illustrates a material deposition apparatus that is filled through its piston, according to an embodiment of the present invention;

FIG. 8 is a drawing that illustrates a material deposition apparatus with a vacuum pump, according to an embodiment of the present invention;

FIG. 9A is a drawing that illustrates a material deposition apparatus with a convex piston and a concave cylinder chamber, according to an embodiment of the present invention;

FIG. 9B is a drawing which illustrates a cylinder with an opening for connection to a vacuum pump and which illustrates a convex piston positioned above the cylinder.

FIG. 10 is a drawing which illustrates a dual cylinder material deposition apparatus with a gearbox and chain or belt drive to control piston movement and switch the associated valve(s) from a single actuator, according to an embodiment of the present invention;

FIG. 11 is a drawing which illustrates an example of a Geneva drive configuration that can be used in a dual cylinder material deposition apparatus and driven by a single actuator, according to an embodiment of the present invention;

FIG. 12 is a drawing which illustrates a material deposition apparatus with gearboxes connected by a driveshaft to drive and switch a plurality of cylinders from a single actuator, according to an embodiment of the present invention;

FIG. 13 is a drawing which illustrates a material deposition apparatus with gearboxes connected by a belt or chain to drive and switch a plurality of cylinders from a single actuator, according to an embodiment of the present invention;

FIG. 14 is a drawing which illustrates a material deposition apparatus with gearboxes where the pistons are moved by a crankshaft, according to an embodiment of the present invention; and

FIG. 15 is a drawing which illustrates a material deposition apparatus with fluid flow paths, channels, one or more heaters, one or more sensors, one or more processors, and a nozzle connected by a diverting valve, according to an embodiment of the present invention.

### DETAILED DESCRIPTION OF THE INVENTION

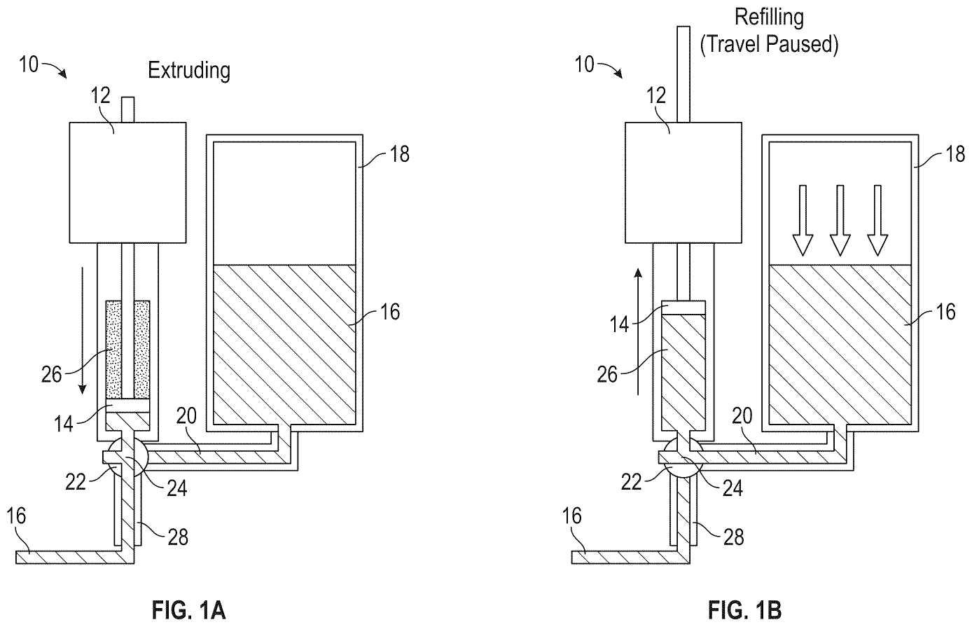

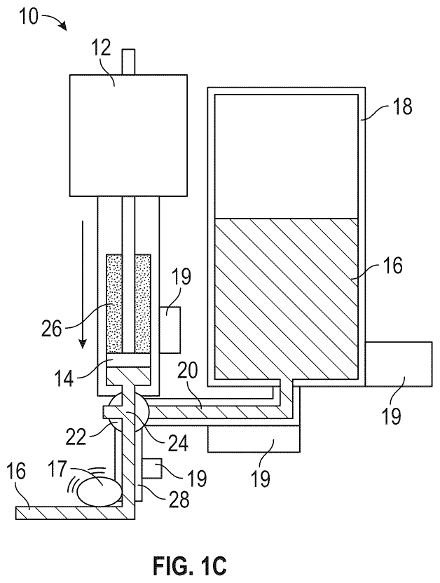

Referring now to the figures, FIG. 1A illustrates material deposition apparatus 10 while extruding. Material deposition apparatus 10 preferably includes actuator 12, coupled to piston 14, to draw deposition material 16 from container 18 by drawing deposition material 16 through container outlet fluid flow path 20 and into valve 22 at valve passageway 24, such that deposition material 16 fills cylinder 26 behind piston 14. Deposition material 16 is preferably extruded through nozzle 28. Material deposition apparatus 10 can operate in both extruding and refilling states to allow precise control of deposition material 16 exiting nozzle 28 while being connected to what can be a much larger container 18. Material deposition apparatus 10 can be an extruder.

FIG. 1B illustrates material deposition apparatus 10 while refilling. In one embodiment, valve 22 preferably rotates such that valve passageway 24 no longer forms a channel with nozzle 28 but maintains a channel with cylinder 26. This allows container 18 to refill cylinder 26 with deposition material 16. This also prevents any deposition material 16 from dispensing out of nozzle 28.

In one embodiment, material deposition apparatus 10 preferably includes a single piston 14 and cylinder 26 fed by one or more containers 18. This configuration can pause extrusion through nozzle 28 regularly to allow cylinder 26 to refill with deposition material 16 from container 18. The spatial motion of material deposition apparatus 10 can also be paused during refilling.

Actuator 12 can include an actuator (including for example a linear actuator) that can be used to control the displacement of a plunger or piston 14 head in cylinder 26. The plunger or piston 14 head can be driven by electric motors (servo motors, stepper motors, etc.) and connected to a lead screw or similar mechanism for converting rotary motion to linear motion, pneumatics, or hydraulics. Precisely controlling the displacement of plunger or piston 14 head results in precise control over the flow rate of deposition material 16 out of nozzle 28. In another embodiment, piston 14 can instead be a diaphragm or other flexible volume displacement barrier. In another embodiment, actuator 12 and piston 14 can be external to cylinder 26, where cylinder 26 is a deformable cylinder, and can act to precisely displace deposition material 16 through progressive cavitation, peristaltic motion, etc.

In one embodiment, as best illustrated in FIG. 1C, nozzle 28 can include tamper/compactor 17, which acts on deposited deposition material 16 to compress or otherwise compact deposition material 16. Optionally, tamper/compactor 17 can be a structure that is separate from nozzle 28. Use of tamper/compactor 17 results in control over the surface quality of deposited material. The tamper/compactor can be actuated to intermittently or continuously compact, vibrate, roll on, or otherwise affect the surface of deposition material 16 in a controlled manner after deposition. Tamper/compactor 17 can act on deposition material 16 directly-for example by physically contacting deposition material 16 or a gas, including but not limited to compressed air, can be emitted by tamper/compactor 17 such that the compressed gas itself is acting on deposition material 16.

Container 18 can be any container which is capable of holding deposition material 16. Common configurations for container 18 holding deposition material 16 can include, but is not limited to, cartridges, syringes, buckets, pails, and drums of varying sizes. Deposition material is forced from container 18 to material deposition apparatus 10 by pneumatics, hydraulics, a linear actuator, or various types of pumps or motors, and can pass through container outlet fluid flow path 20 to get to material deposition apparatus 10 or directly into material deposition apparatus 10 via direct connection to valve 22. Container outlet fluid flow path 20 can include, but is not limited to, a hose, pipe, or other passage through which deposition material 16 can flow. Some deposition materials 16 can be gravity-fed (optionally with vibration and/or heat) rather than forced into material deposition apparatus 10. In one embodiment, deposition material 16 does not flow into cylinder 26 merely by gravity flow alone. In one embodiment, deposition material 16 preferably fills cylinder 26 while piston 14 is traveling away from the end of its maximum stroke length. Most preferably, cylinder 26 is filled throughout at least a majority of the retraction stroke of piston 14. During, or as a way to transfer deposition material 16 into material deposition apparatus 10 and/or deposition material 16 out of nozzle 28, material 16 can be agitated by vibration, tapping, rolling, or other imparted movements, or heated to influence flow viscosity, feed rate, force requirement, etc. as desired for the deposition process. FIG. 1C illustrates a plurality of locations where heater 19 can be provided to provide heat for heating deposition material 16. Optionally, a plurality of heaters 19 can be provided at any one or more locations on material deposition apparatus 10 which will provide thermal conductivity from heater 19 to deposition material 16.

In one embodiment, deposition material 16 can be in a “solid” form (i.e., extremely high viscosity which is essentially solid) in paste, gels, pellets, granules, rods, or filament. This deposition material 16 can be fed into material deposition apparatus 10 using methods other than pumps. For example, a pellet hopper can be gravity-fed and a filament can be fed via rollers. Deposition material 16 can also be stored in a solid form and melted and pumped to material deposition apparatus 10 using something like a pellet extruder.

Many different valve types can be used (ball valve, gate valve, check valve, etc.) to control material flow. Several valves can be used in combination or a single diverting valve can be used.

In one embodiment, container outlet fluid flow paths 20, valves 30, 32, 34, 36, and/or cylinder 26 can be disposable and include sleeves/tubing and/or removable internal liners to minimize cleaning.

Deposition material 16 can include, but is not limited to, polymers, resins, metals, ceramics, composites, glasses, clays, concretes, or a combination thereof. The deposition material can be a composite containing various filler materials including, but not limited to, carbon fiber, glass fiber, other fibers, ceramic particles, graphite, graphene, nitinol, microballoons, curing agents, accelerators, nanoparticles, microparticles, powders, or a combination thereof. Deposition materials may contain additional additives to modify material properties of the raw material (i.e., viscosity, yield strength, curing kinetics, combinations thereof and the like) and/or the final mechanical, thermal, and other properties of the completed part.

Material deposition apparatus 10 can precisely control the flow rate out of nozzle 28 by acting on a small amount of deposition material 16 (the amount in cylinder 26) at any given time. Acting on the small amount of deposition material 16 also enables material deposition apparatus 10 to quickly stop and/or retract extrusion of the deposition material 16.

Using material deposition apparatus 10 allows deposition material 16 to have a very high viscosity. In one embodiment, deposition material 16 has a viscosity of between 1 centipoise (“cP”) and about 10,000,000,000, more preferably between about 10,000 cP and about 10,000,000,000 cP, and most preferably between about 100,000 cP and about 10,000,000 cP. (all measurements made at standard temperature). Material deposition apparatus 10, in both or either single stage or continuous flow configurations, can pump with no limit on material batch size in container 18, however for continuous flow embodiments, material deposition apparatus 10 can continuously deposit deposition material 16 through nozzle 28 without pause. Material deposition apparatus 10 can be an extruder. Actuator 12 preferably pushes on small volumes of deposition material 16 with piston 14, giving precise control over flow rate out of nozzle 28.

In one embodiment, nozzle 28 can include a material mixer such that deposition material 16 and/or multiple deposition materials of different or similar compositions are mixed immediately prior to deposition (including for example before entering nozzle 28 or at one or more locations within nozzle 28—including but not limited to at or near an outlet of nozzle 28). This mixer can be either a passive apparatus that mixes material by virtue of static geometric features, material-driven impellers, permanent magnetic fields, combinations thereof and the like; or active devices that mix material such as impellers, screws, etc. by virtue of an internal or external driving mechanism. This can be advantageous for preparing and/or combining materials which are otherwise difficult to transfer through material deposition apparatus 10 by having them interact only immediately prior to deposition. It can also, for example, allow a combination of deposition materials of one composition with another different composition which instigates curing, hardening, melting, etc. once combined or tailors composition for a particular material behavior.

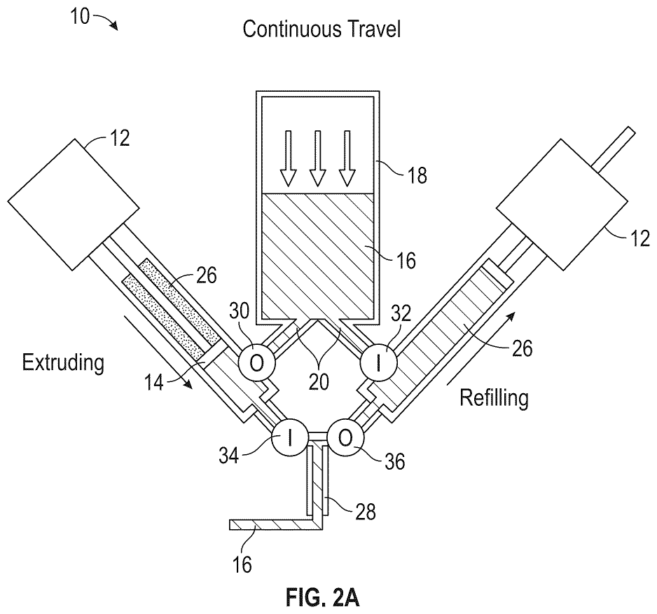

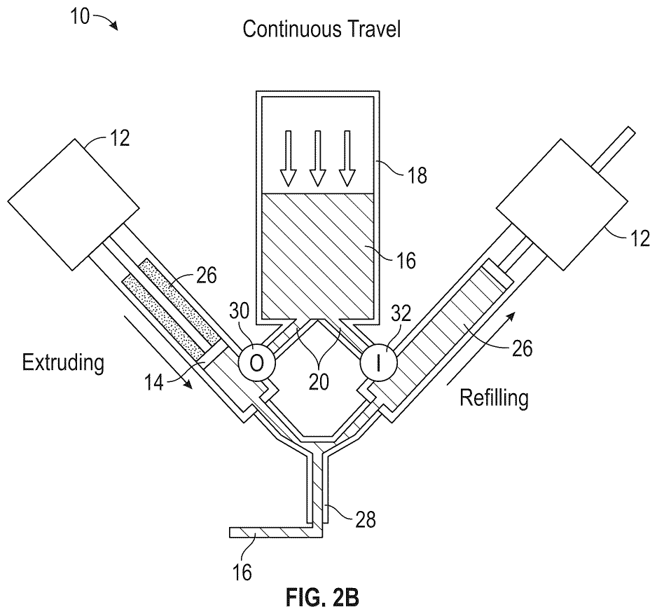

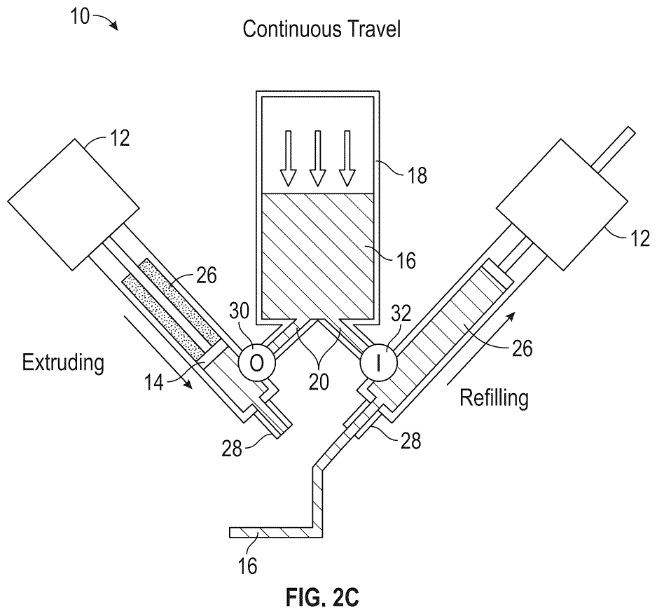

FIG. 2 illustrates an embodiment of material deposition apparatus 10, which can provide continuous flow (such embodiments, which are preferably capable of providing continuous flow, are occasionally referred to herein as “continuous material deposition apparatus 10”). Continuous material deposition apparatus 10 does not require the system to pause its motion r, hence providing continuous extrusion and printing. In one embodiment, deposition apparatus 10 can comprise a 3D printer or a portion of a 3D printer. In this embodiment, deposition materials can comprise print materials. In such systems, if deposition apparatus 10 does not require the system to pause its motion, this enables the 3D printer to avoid pausing its motion relative to a print bed.

In one embodiment, continuous material deposition apparatus 10 can be formed from two or more single cylinder material deposition apparatuses 10, where each preferably includes actuator 12, coupled to piston 14, deposition material 16, and cylinder 26. Continuous material deposition apparatus 10 also preferably includes container 18, which fills each cylinder 26 in material deposition apparatus 10 with deposition material 16. In the embodiment, material deposition apparatus 10 that is extruding preferably includes actuator 12 that pushes piston 14 through cylinder 26. Deposition material 16 flows past valve 30, which is closed off to container outlet fluid flow path 20 in FIG. 2, and through valve 34, which is open in FIG. 2, and out nozzle 28. As illustrated in the figures, valve 34 can be disposed along a fluid flow path between cylinder 26 and nozzle 28. Material deposition apparatus 10 that is refilling preferably includes actuator 12 that pulls piston 14 through cylinder 26. As piston 14 is pulled through cylinder 26, deposition material 16 is pushed from container 18 through container outlet fluid flow path 20 and valve 32, which is open in FIG. 2, refilling material deposition apparatus 10. Valve 36, which can be disposed along a flow path between cylinder 26 and nozzle 28, can be closed to prevent deposition material 16 from entering nozzle 28 while material deposition apparatus 10 is refilling. FIG. 2B illustrates an embodiment where material deposition apparatus 10 is simplified by operating without valves 34 and 36. As the actively extruding material deposition apparatus 10 is moving deposition material 16 out of cylinder 26, material can be permitted to flow into actively refilling material deposition apparatus 10 and from nozzle 28 simultaneously. This results in a predictable and continuous extrusion of material from nozzle 28 while also expediting refill of material deposition apparatus 10, which can be a favorable method of operation for some deposition procedures.

Although any desired method, apparatus, or system can be used for conveying deposition material from a container (16 and/or 42) to a cylinder 26 (optionally through one or more valves), in one embodiment, a compressed gas (which can optionally include compressed air or another gas or mixture of gases) can be applied in a headspace above deposition material that is disposed within the container. Optionally, a movable spacer and/or plunger can be disposed within the container such that the deposition material is below it and the compressed gas is applied above it. Optionally, instead of a compressed gas disposed within a headspace, or in addition to it, a pump can be used to convey the deposition material from the container to one or more cylinders 26. Depending on the desired flow rate and viscosity of the deposition material, gravity flow can optionally be used to convey deposition material from the container to the one or more cylinders (optionally, vibration and/or heat can be applied to encourage the material to flow).

FIG. 2C illustrates another embodiment where material deposition apparatus 10 is further simplified by operating without valves 34 and 36 and by terminating each cylinder 26 with nozzles 28. By co-locating the exits of nozzles 28 in proximity to each other such that they deposit material 16 in the same approximate location, material deposition apparatus 10 can be similarly operated without the need for additional control points and without material being transferred from one material deposition apparatus to another.

One material deposition apparatus 10 extrudes deposition material 16 while the other material deposition apparatus 10 is being refilled with deposition material 16 by container 18. Then, when one material deposition apparatus 10 that is extruding deposition material 16 runs out of deposition material 16, the other material deposition apparatus 10 can begin extruding deposition material 16 while the first material deposition apparatus 10 begins refilling deposition material 16. This process can switch back and forth, allowing continuous material deposition apparatus 10 to continuously deposit deposition material 16 without stopping.

In one embodiment, continuous material deposition apparatus 10 preferably includes two or more material deposition apparatuses 10 fed by one or more containers 18. Deposition material 16 is pumped from container 18 into cylinder 26, where it is pushed by piston 14 out of nozzle 28 at a controlled rate. Most preferably, alternate piston 14 strokes are made so that one is extruding while the other is refilling, enabling continuous extrusion. One or more valves (valves 30, 32, 34, and 36) open/close to control the flow into and out of cylinders 26. The nature of material deposition apparatus 10 controlling the extrusion makes this a positive displacement pump (or a metering pump). Container 18 of deposition material 16 is preferably pressurized to force deposition material 16 into material deposition apparatus 10.

Material deposition apparatus 10 can precisely control the flow rate out of nozzle 28 by acting on a small amount of deposition material 16 (the amount in cylinder 26) at any given time. Acting on the small amount of deposition material 16 also enables material deposition apparatus 10 to more quickly stop and/or retract extruding deposition material 16 through nozzle 28.

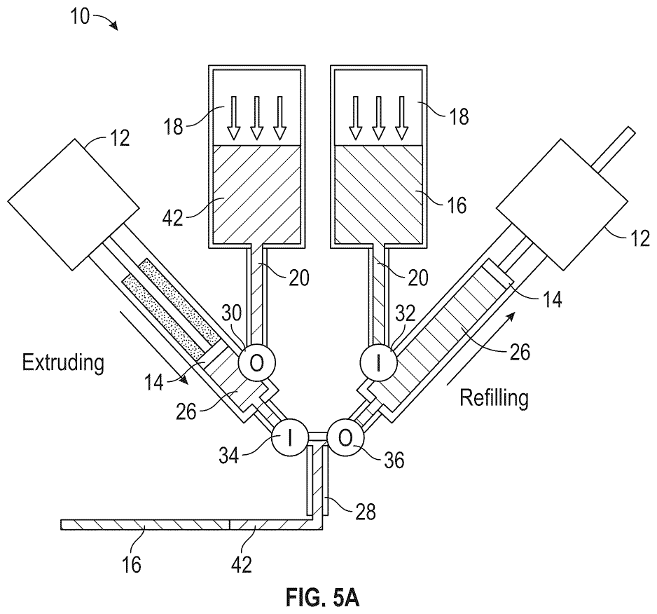

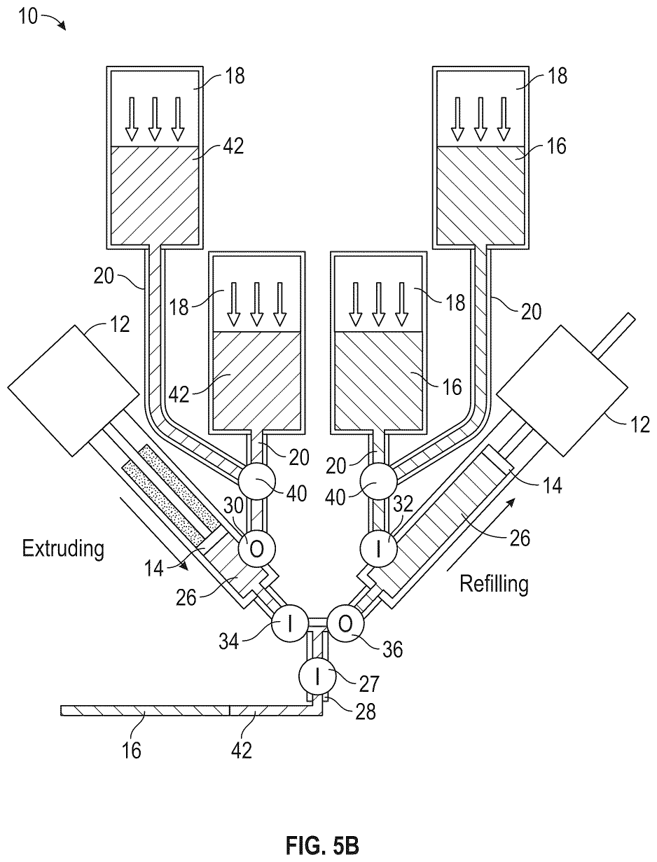

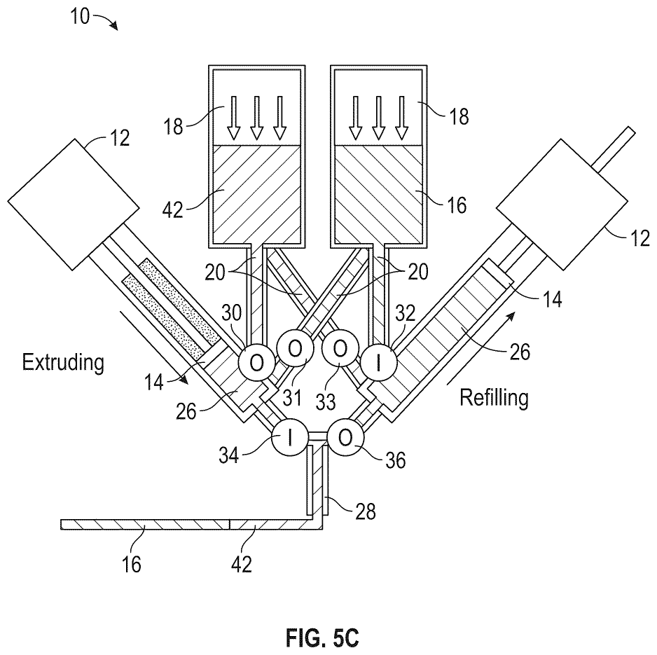

Using material deposition apparatus 10 allows deposition material 16 (and deposition material 42) to have a very high viscosity. Material deposition apparatus 10 can extrude through nozzle 28 continuously (no limit on material batch size). Actuator 12 preferably pushes on small volumes of deposition material 16 at a time, giving precise control over flow rate out of nozzle 28. Material deposition apparatus 10 also reduces pressure needed to extrude, minimizes effects of compressibility, and gives the ability to retract & start/stop flow quickly. Optionally, stop valve 27 (see FIG. 5B for example) can be provided just before the point of deposition from nozzle 28 can enable immediate start/stop flow of materials out of nozzle 28. Alternatively, valves 34 and/or 36 can be shut to stop flow of materials.

Material deposition apparatus 10 can optionally be configured to print from multiple containers 18, which is helpful for thermosets, aqueous ceramics, combinations thereof and the like, which have limited pot life or change rheological behavior over time. Containers 18 can be manually or autonomously replaced or refilled with any deposition material 16 at any point during or after a printing operation to increase the duration of the operation or to modify materials in use.

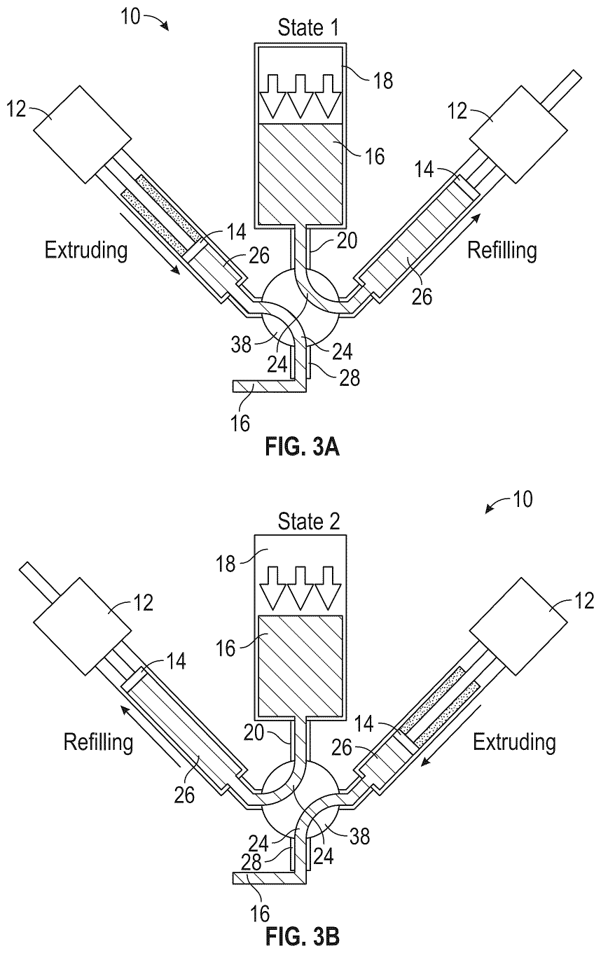

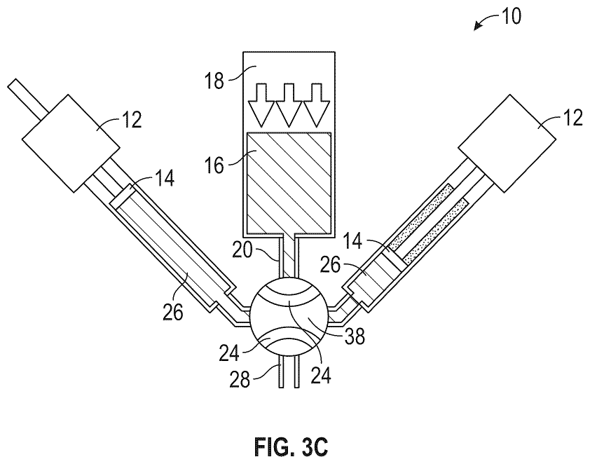

In one embodiment, material deposition apparatus 10 can include a diverting valve 38, as illustrated by FIG. 3A and FIG. 3B. FIG. 3A illustrates material deposition apparatus 10 in a first state (State 1). Diverting valve 38 preferably comprises one or more channels 24. Diverting valve 38 can rotate from 0 to 360 degrees clockwise and/or counterclockwise, or to any position in between. In this embodiment, continuous material deposition apparatus 10 can be formed by combining two non-continuous flow embodiments of material deposition apparatus 10, where each material deposition apparatus 10 preferably includes actuator 12, coupled to piston 14, deposition material 16, and cylinder 26. Continuous material deposition apparatus 10 also preferably includes container 18, which fills cylinder 26 in each material deposition apparatus 10 with deposition material 16. Material deposition apparatus 10 that is extruding preferably includes actuator 12 that pushes piston 14 through cylinder 26. Deposition material 16 flows into channel 24 and out nozzle 28. Material deposition apparatus 10 that is refilling preferably includes actuator 12 that pulls piston 14 through cylinder 26. As piston 14 is pulled through cylinder 26, deposition material 16 is pushed from container 18 through container outlet fluid flow path 20 and channel 24, refilling material deposition apparatus 10. Diverting valve 38 can be rotated, changing pathways created by channels 24. Diverting valve 38 can include pathways from one material deposition apparatus 10 to nozzle 28, and the other material deposition apparatus 10 to container 18 (as illustrated in FIG. 3A). Diverting valve 38 can be rotated 90 degrees such that there are pathways from the other material deposition apparatus 10 to nozzle 28, and the one material deposition apparatus 10 to container 18 (as illustrated in FIG. 3B). Diverting valve 38 can be rotated to a position such that there are no pathways for deposition material 16 to flow through diverting valve 38 to immediately stop deposition material 16 flow out of nozzle 28 (for non-print moves) and stop deposition material 16 from refilling cylinder 26 (as illustrated in FIG. 3C).

FIG. 3B illustrates continuous material deposition apparatus 10 in a second state (State 2). Diverting valve 38 can rotate, switching continuous material deposition apparatus 10 from State 1 to State 2, and/or State 2 to State 1, and/or from either state to an intermediary state. Diverting valve 38 preferably switches and controls which material deposition apparatus 10 is being refilled, and which material deposition apparatus 10 is extruding. Material deposition apparatus 10 that was extruding in FIG. 3A is being refilled in FIG. 3B. Material deposition apparatus 10 that was being refilled in FIG. 3A is extruding in FIG. 3B.

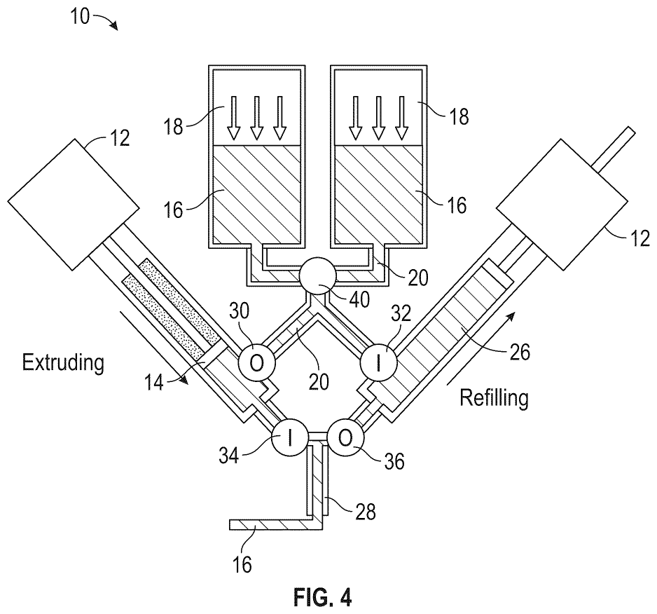

In one embodiment, as illustrated in FIG. 4, material deposition apparatus 10 can include multiple containers 18. Two or more containers 18 can be used, where each includes a container outlet fluid flow path 20. Container outlet fluid flow paths 20 meet at valve 40, where valve 40 controls which container 18 deposition material 16 comes from. Valve 40 can allow deposition material 16 to flow from two or more containers 18 simultaneously to mix material. Deposition material 16 can flow from valve 40 to valve 30 and valve 32, selectively allowing or denying deposition material 16 to flow into cylinders 26. Valve 40 can allow deposition material 16 to flow from one container 18, both containers 18, and/or block flow from both containers 18. Valve 40 can be adjusted such that varying amounts of deposition material 16 flows from each container 18.

Material deposition apparatus 10 can be fed from several containers 18 of the same or different deposition materials 16 if desired. This enables deposition of multiple materials in a single part as well as continuous printing of large parts using multiple batches of deposition material. One particular benefit is, for example, if a deposition material has a 6-hour pot life but the print takes 18 hours to print, several small batches can be prepared at different times and printed without interruption. Additionally, large vacuum centrifugal mixers often mix two batches of materials at one time, so it can be advantageous to extrude from both batches separately. Although embodiments of the present invention can optionally be used for 3D printing, embodiments of the present invention can optionally be used to provide two dimensional (2D) prints (for example a single layer).

FIG. 5A illustrates an embodiment where material deposition apparatus 10 includes two containers 18, where each hold deposition material 16, a second deposition material (deposition material 42), and/or both. Note that the teachings within this application which reference only “deposition material 16” are merely done for simplicity and consistency. It is to be understood that such teachings can be extended to also apply to deposition material 42. Deposition material 16 and/or deposition material 42 can enter one material deposition apparatus 10 through container outlet fluid flow path 20 and valve 30. Deposition material 16 and/or deposition material 42 from the other container 18 can enter another material deposition apparatus 10 through container outlet fluid flow path 20 and valve 32. Valve 30 and valve 32 can open or close depending on which material deposition apparatus 10 is extruding and which material deposition apparatus 10 is refilling. Valve 34 and valve 36 control which deposition material enters nozzle 28. In the embodiment illustrated in FIG. 5A, valve 32 and valve 34 can be open and deposition material 16 and/or deposition material 42 can be extruded out of nozzle 28. Containers 18 can hold either a discrete or open volume of deposition material 16 and/or deposition material 42. In the case where container 18 has a discrete capacity and is depleted through operation of material deposition apparatus 10, the container can be replaced either by the operator or autonomous systems while the other container 18 is used for operations. In one embodiment, container 18 can directly integrate with an external material preparation mixer to allow immediate use of deposition materials with, for example, extremely limited pot life.

FIG. 5B illustrates another embodiment where continuous material deposition apparatus 10 includes four or more containers 18, where one set holds deposition material 16, and the other holds deposition material 42. Deposition material 16 can be a different or the same material as deposition material 42. Deposition material 42 enters a first of a plurality of cylinders 26 through container outlet fluid flow path 20 and valve 30. Deposition material 16 enters a second cylinder 26 through container outlet fluid flow path 20 and valve 32. Fluid flow path 20 can optionally comprise one or more tubes, pipes, hoses, or other structures through which fluid can be conveyed. Valve 30 and valve 32 can open or close depending on which cylinder 26 is extruding and which cylinder 26 is refilling. Valve 34 and valve 36 control which deposition material enters nozzle 28. In the embodiment illustrated in FIG. 5B, valve 32 and valve 34 are open and deposition material 42 is being extruded out of nozzle 28. When continuous material deposition apparatus 10 switches from printing deposition material 16 to deposition material 42, a residual from the deposition material 16 is left ahead of deposition material 42 after they are extruded from nozzle 28. This allows a user to switch back and forth between deposition material 16 and deposition material 42 to create an object that is comprised of more than one deposition material or the same deposition material. In one embodiment, all of valves 30, 32, 34, and 36 can be open simultaneously to allow mixing of deposition materials 16 and 42 as they enter nozzle 28. Operations in this state can enable, for example, printing of two-or-more part epoxies.

FIG. 5C illustrates another embodiment where continuous material deposition apparatus 10 includes two or more containers 18 where each container is connected to material deposition apparatus 10 by container outlet fluid flow paths 20. In this configuration, a plurality of cylinders 26 (for example first and second cylinders 26) are provided and any of them can be refilled from any container 18 such that while deposition material 16 or 42 is being forced from one of them, another cylinder 26 is refilled with the same deposition material. In this embodiment, deposition material 16 can be selected by opening valves 31 and 32 and closing valves 30 and 33, and vice versa for deposition material 42. In this embodiment, refilling either of cylinders 26 with one material can be performed while still extruding with the other cylinder. By switching the states of valves 30, 31, 32, 33, 34, and 36, continuous material deposition apparatus 10 can rapidly switch between depositing material 16 and 42, which can enable, for example, multi-material printing.

As with deposition material 16, deposition material 42 can also optionally include, but is not limited to, polymers, resins, metals, ceramics, glasses, clays, concretes, or a combination thereof. The deposition material can be a composite containing various filler materials including, but not limited to, carbon fiber, glass fiber, other fibers, ceramic particles, graphite, graphene, nitinol, microballoons, curing agents, accelerators, nanoparticles, microparticles, powders, or a combination thereof. Deposition materials may contain additional additives to modify material properties of the raw material (i.e., viscosity, yield strength, curing kinetics, or any other desired property) and/or the final mechanical, thermal, and other properties of the completed part.

In one embodiment, material deposition apparatus 10 can include operator signaling interfaces including, but not limited to, lights, speakers, responsive or color changing materials, or a combination thereof. Operator signaling interfaces indicate system status. This allows operators to determine what current operation is taking place, which material deposition apparatus 10 is in which stage of refill/extrusion, and/or the current condition of the deposition material 16. These signaling interfaces are vital to printing operations when the internal configuration of the embodiment is not visually discernable. They also provide valuable information for gauging system and material performance in case unexpected conditions arise.

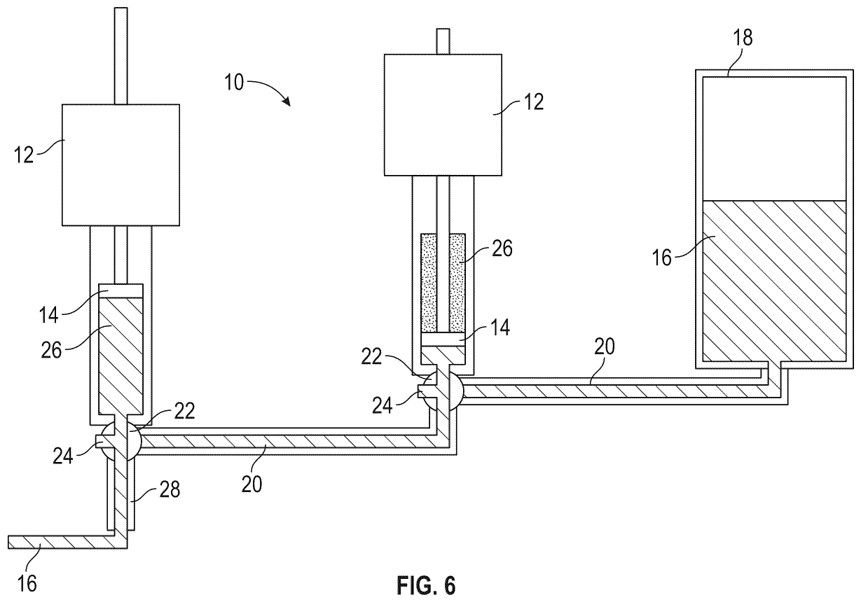

In one embodiment, one or more material deposition apparatus 10 can be placed in series, as illustrated in FIG. 6. Deposition material 16 flows from container 18, through container outlet fluid flow path 20, to valve 22 with channel 24. Channel 24 preferably comprises a three-way junction within valve 22 such that when valve 22 rotates, channel 24 forms a pathway for deposition material 16 to flow either from container outlet fluid flow path 20 to material deposition apparatus 10, or from container outlet fluid flow path 20 to a different container outlet fluid flow path 20. Using more than one material deposition apparatus 10 in series allows material deposition apparatus 10 and nozzle 28 to extrude deposition materials 16 that have high viscosity. Using more than one material deposition apparatus 10 in series also allows material deposition apparatus 10 to extrude deposition materials 16 through nozzle 28 over longer distances and lower pressures. Since each material deposition apparatus 10 acts as a pump, it can be used to pump deposition material 16 over distance. In the case of highly viscous materials, often high pressures are used and can damage certain deposition materials, for example, microballoons can be crushed, or mixed materials (slurries, etc.) can separate or become non-uniform. Putting several material deposition apparatuses 10 in series reduces the maximum pressure a material experiences during pumping. Each material deposition apparatus 10 can have a different mechanism of action and each piston 14 can be of a different design (as detailed above) to enable differing methods of control over material transfer. For example, if material deposition apparatus 10 nearest container 18 features a pneumatic pump, the further material deposition apparatus 10 can feature a metering screw to allow for more precise deposition.

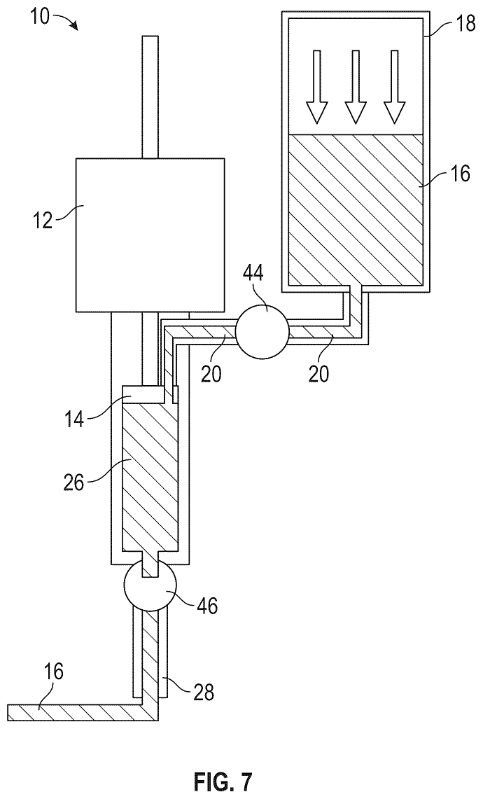

In one embodiment, deposition material 16 can be filled into material deposition apparatus 10 through piston 14, as illustrated in FIG. 7. In this embodiment, deposition material 16 enters cylinder 26 through a hole in piston 14. Deposition material 16 preferably flows through container outlet fluid flow path 20, through valve 44, positioned along fluid flow path 20, through another container outlet fluid flow path 20, then through a hole in piston 14 and into cylinder 26. Container outlet fluid flow paths 20 can be rigid or flexible to allow them to move as piston 14 moves. Valve 44 can stop or allow deposition material 16 to flow through container outlet fluid flow paths 20. Filling deposition material 16 into cylinder 26 through a hole in piston 14 can provide a better method of preventing air bubbles from entering material deposition apparatus 10. Optionally, valve 46 can be disposed between cylinder 26 and nozzle 28 along a fluid flow path extending there between.

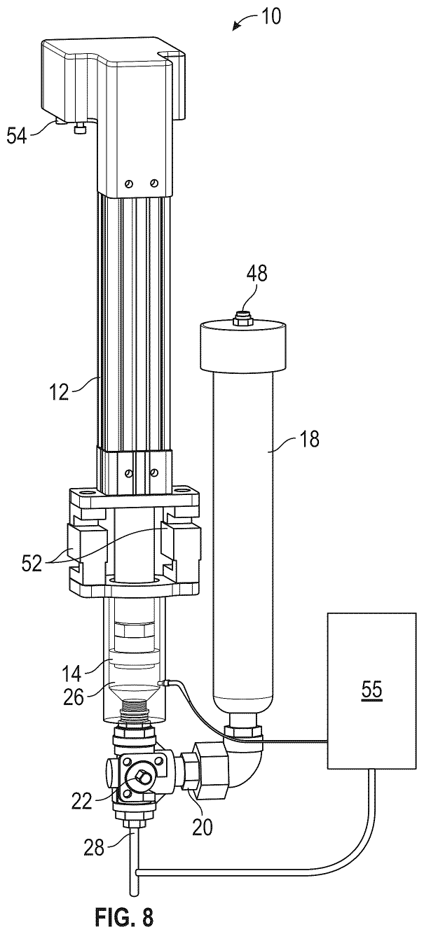

FIG. 8 illustrates material deposition apparatus 10 with load cells 52. Also illustrated are container port 48 and motor mount 54. Load cells 52 can be in different locations on material deposition apparatus 10. Load cells 52 can be replaced or augmented with other types of sensors, including but not limited to pressure sensors, which can be incorporated onto material deposition apparatus 10 to measure the compliance of the system and operate in a feedback loop to enable precise flow rates. There is compliance in every material deposition apparatus 10 regardless of deposition material 16 because the individual components of material deposition apparatus 10 strain under load. Load cells 52 are preferably used with deposition materials 16 that are compressible materials but can also be used for incompressible materials. Compressible materials compress prior to beginning to flow out of nozzle 28, which results in a lower initial flow rate. Load cells or other sensors can detect this and correct the actuator displacement in a feedback loop to reach and maintain the desired flow rate. Sensors can also directly measure the flow rate and control it in this way. Optionally, vacuum pump 55 can be communicably coupled to cylinder 26 and/or nozzle 28.

Vacuum pumps 55 and associated vacuum ports 56 can optionally be used on all configurations and can vary in placement. These can be used to eliminate air entrapment during the initial fill and subsequent refills. Vacuum pumps 55 and associated vacuum ports 56 can also be used as a way to promote material transfer by creating negative pressure zones to be filled by deposition material 16. Vacuum port 56 can include a controllable valve to open, close, or meter vacuum flow at any point in the deposition process to achieve specific pressures. Load cells 52 or other sensors can be used to measure pressure in certain locations of material deposition apparatus 10. Elimination of air entrapment and material transfer allows for elimination of porosity in the deposited material and is useful to conduct off-gassing of loaded materials for vapors that would otherwise be trapped in the system.

In addition to or in place of load cells 52, sensors can also be located at actuator 12 and/or at nozzle 28 to measure flow rate by torque/force feedback, visual signal, electromagnetic (e.g., microwave) response, etc. This feedback can be either absolute or relative as a means of determining material deposition behavior. This feedback can be integrated into closed control loops to create a smart deposition system which can, for example, precisely and selectively control the amount of material that is extruded. Feedback from such sensors can also, for example, be used to preload compressible deposition material 16 to prepare it for instant extrusion when commanded and/or to compensate for extrusion lag when switching between cylinders 26.

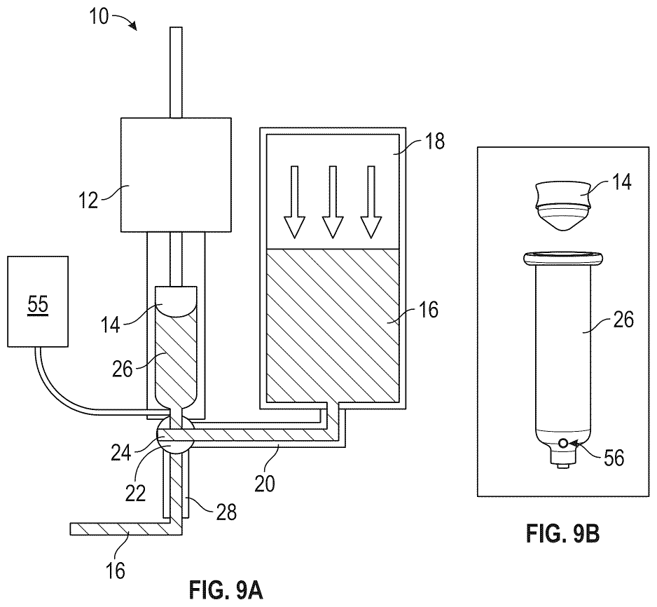

FIG. 9A illustrates material deposition apparatus 10 with piston 14 and cylinder 26 that have an alternate shape. In one embodiment, piston 14 can be a convex shape and cylinder 26 can have a matching concave bottom end opposite where piston 14 is. In another embodiment, piston 14 can have alternative configurations as described above. As best illustrated in FIG. 9A, vacuum pump 55 can be coupled to cylinder 26, most preferably near an end portion thereof. This can enable any entrapped air to be removed-particularly at the beginning and/or end of the stroke of piston 14. FIG. 9B illustrates cylinder 26 with vacuum port 56, to which vacuum pump 55 can be connected. Other geometries (e.g., flat, conical, concave, convex, etc.) can optionally be used on the bottom of cylinder 26 with piston 14 having a shape that fits into, onto, or around it—most preferably so that a mating interface is formed between the two. Different shaped cylinders 26 and pistons 14 can reduce the ability for air to be entrained within deposition materials 16.

In one embodiment, material deposition apparatus 10 can be a heated, chilled, and/or include a vibration system (for example, containers, nozzles, cylinders, fluid flow paths, valves, etc.). Heating methods can include, but are not limited to, resistance heaters, water heating (heat exchanger), air heating, microwaves, infrared, induction, and/or a combination thereof. Cooling methods can include, but are not limited to, water cooling (or using a refrigerant), air cooling (or another gas), Peltier effect coolers, ice, liquid nitrogen, dry ice, and/or a combination thereof. Vibration methods can include, but are not limited to piezoelectric actuators, ultrasonic, electromagnetic, resonant acoustic, eccentric rotating mass motors, and/or a combination thereof. All or some parts of material deposition apparatus 10 can be heated, chilled, and/or vibrated. Heating can be used to reduce the viscosity of deposition material 16 to enable better flow, while chilling can be used to keep deposition material 16 cool and extend its useful pot life, and vibration can enable material flow of deposition materials 16 with filler content (e.g., chopped/milled fibers) that may tend to get stuck to walls/surfaces. Thermocouples or other temperature sensing devices and supporting circuitry can be included at various points in the system to control the heating or chilling systems in a feedback loop. Vibration systems can have tunable frequencies and/or amplitudes that can improve material flow and be utilized in a feedback loop.

In one embodiment, material deposition apparatus components can be made radio frequency (“RF”)-transparent so that the material inside can be heated using microwaves and/or induction fields. Various material deposition apparatus components can be made out of materials that are transparent to microwaves (i.e., RF-transparent) to allow for microwave and/or induction heating of the deposition material within the material deposition apparatus. This preferably provides more uniform volumetric heating than other methods. It also provides quicker heating and is more energy efficient than other methods. Likewise, any portions wherein microwave and/or induction heating is specifically not desired can be shielded therefrom by applying a radio frequency reflective or attenuative shielding material over them.

In one embodiment, material deposition apparatus 10 can include various single use/disposable parts where deposition material 16 is in contact with the system to eliminate the need for cleaning between prints.

Since pressure builds up in material deposition apparatus 10 in order to extrude, a controlled discharge valve can be included near nozzle 28. Therefore, when stopping extrusion, the valve can be opened to relieve the internal pressure and prevent excess deposition material 16 from oozing out of nozzle 28.

Since material deposition apparatus 10 can act as a metering pump, it can be used for two-component thermoset materials that require mixing prior to deposition. Essentially, this includes using any of the described configurations to control each of the two components, forcing them through a static mixer (or another mixer) prior to exiting nozzle 28.

In one embodiment, some deposition materials 16 can be sufficiently viscous and self-adherent to allow deposition in any spatial orientation of each configuration of material deposition apparatus 10 described herein. Use of short pot-life or curable materials (e.g., by UV, microwave, induction, other means of heating/hardening/curing, etc.) especially enables this capability as the material can be quickly cured in place upon exiting nozzle 28. Controlling the orientations of material deposition apparatus 10, and especially of nozzle 28 allows for multi-axis and conformal deposition of deposition material 16.

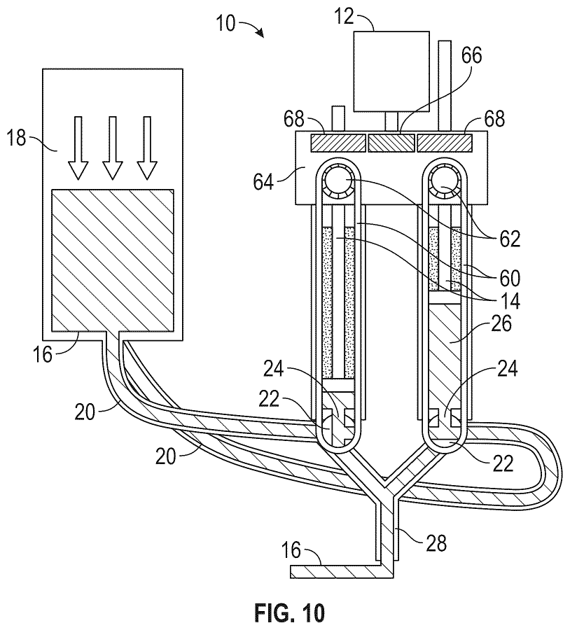

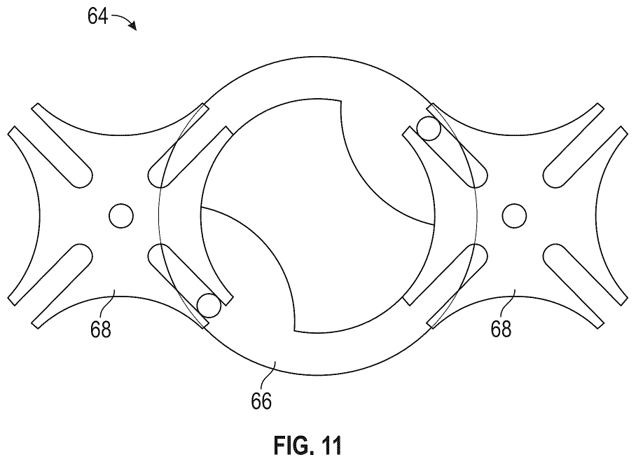

In one embodiment, a single motor can be used to control multiple actuators via any known method to transfer mechanical energy, including but not limited to gears, belts and pulleys, chain drives and sprockets, drive shafts, hydraulic motors and pumps, combinations thereof and the like that connect them together. Likewise, a single drive motor can be used to drive a plurality of pistons 14 in separate cylinders 26, and one or more valves that are coupled to the cylinders can optionally be driven by one or more other motors—in this configuration, a timing or other synchronizing system is preferably used—for example to actuate the respective valves at top dead center of each stroke (or at the bottom thereof). Such synchronizing system can include for example one or more electrical sensors that detect a position of one or more of the pistons and the output of which can be used to trigger the switching of one or more valves FIG. 10 illustrates material deposition apparatus 10 including chains 60, sprockets 62, gearbox 64, motor gear 66, and piston gears 68. Gearbox 64 can be powered by a single actuator 12, where actuator 12 can be a motor. Actuator 12 preferably drives motor gear 66, which in turn drives piston gears 68. As piston gears 68 rotate, pistons 14 draw deposition material 16 from container 18 through one or more container outlet fluid flow paths 20 and into one or more valves 22 at valve passageways 24, such that deposition material 16 fills cylinder 26 behind piston 14. Deposition material 16 is preferably extruded through nozzle 28. One or more pistons 14 and cylinders 26 can be used such that as one cylinder is refilling, another is extruding. Nozzle 28 can be a junction nozzle such that one or more outlets from valve passageways 24 merge into a single exit within nozzle 28.

Sprockets 62 can be rotated, causing chain 60 to rotate valves 22. Valve 22 can be rotated to allow cylinder 26 to be refilled with deposition material 16 and block valve passageway 24 to nozzle 28, preventing extrusion. Valve 22 can be rotated to allow cylinder 26 to extrude deposition material 16 and block valve passageway 24 to container 18, preventing refilling. One or more sprockets 62, chains 60, and valves 22 can be used such that as one cylinder 26 is being refilled, another is extruding, allowing the continuous extrusion of deposition material 16 from nozzle 28.

Gearbox 64 can include motor gear 66 and piston gears 68. Motor gear 66 can be connected to actuator 12 (a motor) to provide an input to gearbox 64 and continuous rotation. Piston gears 68 can be connected to pistons 14 to provide an output from gearbox 64 and continuous rotation. Sprockets 62 and chains 60 can be connected to valves 22 to intermittently rotate 90°.

FIG. 11 illustrates gearbox 64. Gearbox 64 can optionally be a Geneva mechanism used to rotate sprockets 62 intermittently 90° while the input shaft continuously rotates. Other types of gears that can be used within gearbox 64 can include, but are not limited to, rack and pinion gears for linear actuation, cams, or a combination thereof.

Valves 22 can be a single valve, multiple independent valves, or multiple valves connected together via gears, pulleys, etc. In one embodiment, actuators 12 and valves 22 together can be used to control material deposition apparatus 10 using single motor.

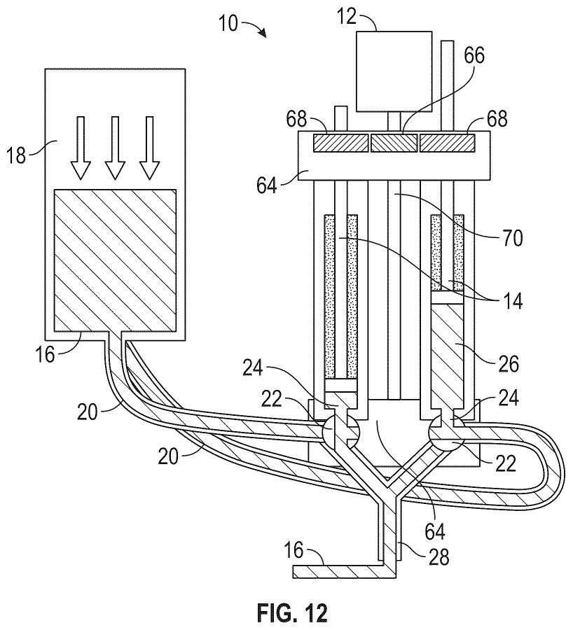

In one embodiment, material deposition apparatus 10 can include one or more gearboxes connected by a driveshaft. FIG. 12 illustrates material deposition apparatus 10 including one or more gearboxes 64, motor gear 66, piston gears 68, and driveshaft 70. One gearbox 64 can be powered by actuator 12, where actuator 12 can be a motor. Actuator 12 preferably drives motor gear 66, which in turn drives piston gears 68. One gearbox 64 can be connected to another gearbox 64 via driveshaft 70. One gearbox 64 can translate motor motion into piston 14 motion, while the other gearbox 64 translates driveshaft motion into valve 22 motion.

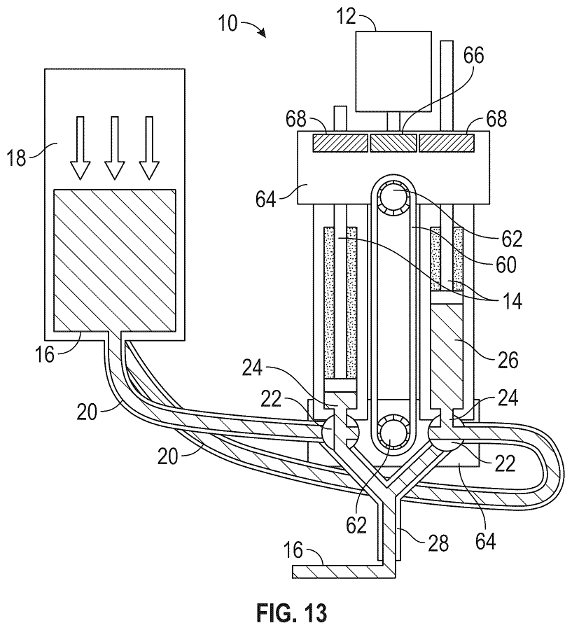

In one embodiment, material deposition apparatus 10 can include one or more gearboxes connected by a belt or chain. FIG. 13 illustrates material deposition apparatus 10 including one or more gearboxes 64, motor gear 66, piston gears 68, chains 60, and sprockets 62. One gearbox 64 can be powered by actuator 12, where actuator 12 can be a motor. Actuator 12 preferably drives motor gear 66, which in turn drives piston gears 68. One gearbox 64 can be connected to another gearbox 64 via chains 60 and sprockets 62. One gearbox 64 can translate motor motion into piston 14 motion, while the other gearbox 64 translates chain and sprocket motion into valve 22 motion.

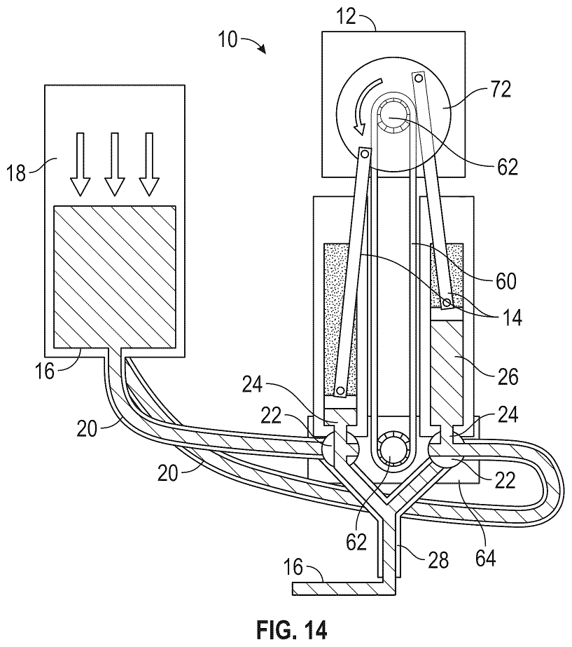

In one embodiment, material deposition apparatus 10 can include one or more gearboxes where the pistons are moved by a crankshaft. FIG. 14 illustrates material deposition apparatus 10 including one or more gearboxes 64, chains 60, sprockets 62, and crankshaft 72. Actuator 12 preferably drives crankshaft 72 and sprocket 62, which in turn drives gearbox 64 via chains 60 and sprockets 62. Crankshaft 72 can translate motor motion into piston 14 motion, while gearbox 64 translates chain and sprocket motion into valve 22 motion.

Crankshaft 72 can be rotated by actuator 12. As crankshaft 72 rotates, one or more pistons 14 can be moved along the inside of cylinder 26. Pistons 14 can include connecting rods that can pivot about the piston head. The connecting rods can be coupled with crankshaft 72 such that as crankshaft 72 rotates, one cylinder 26 is refilled and another cylinder 26 is extruding, allowing for continuous extrusion of deposition material 16 from nozzle 28. Although the foregoing discusses embodiments where chains and sprockets are used, belts and pulleys can of course be substituted therefor including toothed belts and toothed pulleys. Although the figures illustrate a single reservoir, multiple reservoirs can be used.

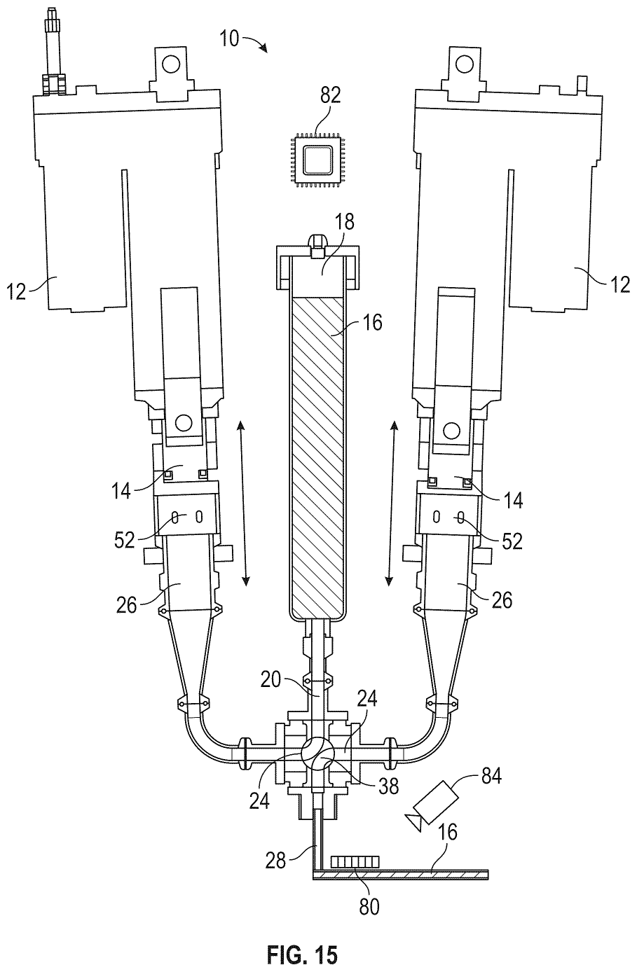

FIG. 15 illustrates an embodiment of material deposition apparatus 10 in which fluid flow paths 20 and channels 24 and nozzle 28 are connected by diverting valve 38. Material deposition apparatus 10 can incorporate one or more sensors 52, which can optionally be force sensing (for example load cells and/or strain gauges), and/or other electrical sensors which can enable closed-loop control and/or data collection from the action of piston 14 on material deposition apparatus 10 and on deposition material 16. Diverting valve 38 can rotate from 0 to 360 degrees clockwise or counterclockwise, or to any position in between. In one embodiment, diverting valve 38 can be rotated 90 degrees such that there are pathways from the other material deposition apparatus 10 to nozzle 28, and the one material deposition apparatus 10 to container 18. Diverting valve 38 can be rotated to a position such that there are no pathways for deposition material 16 to flow through diverting valve 38 to immediately stop deposition material 16 flow out of nozzle 28 (for cessation of extrusion and/or non-print moves) and stop deposition material 16 from refilling cylinder 26.

As best illustrated in FIG. 15, in one embodiment, heater 80 can be provided to heat and cure deposition material as it is exiting nozzle 28 and/or immediately thereafter. In one embodiment, heater 80 can be an induction heater such that it comprises an induction field generator. As illustrated, heater 80 can be placed around or near nozzle 28 (or at any other location where induction would cause heating of deposition material 16). Some compositions of nozzle 28 and/or deposition material 16 can be susceptive to inductive heating such that the temperature of deposition material 16 can be desirably affected by the influence of the inductive field. This can be used to rapidly cure or harden material exiting nozzle 28 or to control its viscosity for more favorable flow characteristics such as viscosity, flow rate, etc. Feedback from one or more sensors 84 can be collected. For example, sensors 84 can be capable of directly detecting the foregoing characteristics and/or indirect effects of those characteristics such as temperature, mass loading, inductive response, etc. The output of one or more sensors 84 can be input into control unit 82 which can optionally include for example a microcontroller, microprocessor, field programmable gate array (“FPGA”) and/or other circuit. Control unit 82 can be coupled to activate any of the various valves described throughout this application, as well as the actuators and optionally any heaters and/or tamper compactors. Control unit 82 can be programmed with any firmware and/or software such that it can monitor the various sensors, including for example load cells 52 and/or sensors 84, and make adjustments-preferably in real time to enable system 10 to run autonomously and/or semi-autonomously. In one embodiment, one or more sensors 84 can include one or more of a video camera and/or an infrared camera.

The preceding examples can be repeated with similar success by substituting the generically or specifically described components and/or operating conditions of embodiments of the present invention for those used in the preceding examples.

The terms, “a”, “an”, “the”, and “said” mean “one or more” unless context explicitly dictates otherwise. Optionally, embodiments of the present invention can include a general or specific purpose computer or distributed system programmed with computer software implementing steps described above, which computer software may be in any appropriate computer language, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitory memory-storage devices.

Note that in the specification and claims, “about”, “approximately”, and/or “substantially” means within twenty percent (20%) of the amount, value, or condition given. All computer software disclosed herein may be embodied on any non-transitory computer-readable medium (including combinations of mediums).

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and this application is intended to cover, in the appended claims, all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguring their relationships with one another.

What is claimed is:

1. A material deposition apparatus comprising:
a first deposition material container;
a first cylinder communicably coupled to said first deposition material container via a first fluid flow path, the first fluid flow path extending from at least said first deposition material container to at least said first cylinder,
a first piston disposed at least partially within said first cylinder, said first piston configured to exert a force upon a first deposition material when the first deposition material is disposed within said first cylinder;
a first valve capable of being selectively arranged into:
a first valve open position, and
a first valve closed position;
said first valve disposed such that when arranged into the first valve closed position, a first flow of fluid from said first deposition material container to said first cylinder is impeded or blocked; and
a nozzle.

2. The material deposition apparatus of claim 1 further comprising a first actuator communicably coupled to said first piston.

3. The material deposition apparatus of claim 1 wherein said first valve can be operated independently from actuation of said first piston.

4. The material deposition apparatus of claim 1 further comprising:
a second cylinder;
a second piston; and
a second valve, said second valve capable of being selectively arranged into:
a second valve open position, and
a second valve closed position.

5. The material deposition apparatus of claim 4 further comprising a second nozzle.

6. The material deposition apparatus of claim 4 wherein said second valve is disposed such that when said second valve is arranged into the second valve closed position, a second flow of fluid from said first deposition material container to said second cylinder is impeded or blocked.

7. The material deposition apparatus of claim 4 further comprising a second deposition material container and said second valve disposed such that when said second valve is arranged into the second valve closed position, a flow of fluid from said second deposition material container to said second cylinder is impeded or blocked.

8. The material deposition apparatus of claim 4 further comprising a third valve disposed between an outlet of said first cylinder and said nozzle.

9. The material deposition apparatus of claim 4 further comprising a fourth valve disposed between an outlet of said second cylinder and said nozzle.

10. The material deposition apparatus of claim 4 wherein said material deposition apparatus is configured such that when said first valve is in the first valve open position, said second valve is in the second valve closed position and wherein when said first valve is in the first valve closed position, said second valve is in the second valve open position.

11. The material deposition apparatus of claim 4 wherein said material deposition apparatus is configured such that when said first piston is being retracted, said first cylinder is filled with the first deposition material while said second piston is simultaneously being advanced and said second cylinder conveys the first deposition material or another deposition materials.

12. The material deposition apparatus of claim 4 wherein said nozzle is communicably coupled to an outlet of said first cylinder and an outlet of said second cylinder.

13. The material deposition apparatus of claim 4 further comprising a second deposition material container and wherein said material deposition apparatus is configured to allow said first cylinder and said second cylinder to selectively be refilled from either said first deposition material container or said second deposition material container.

14. The material deposition apparatus of claim 1 further comprising a pressurized fluid filling a headspace of said first deposition material container.

15. The material deposition apparatus of claim 1 wherein said first valve comprises a plurality of flow paths on a rotatable member such that any of said plurality of flow paths are selectable and such that none of said plurality of flow paths are selectable.

16. The material deposition apparatus of claim 1 further comprising a compactor positioned and configured to provide compaction of the first deposition material after exiting said nozzle.

17. The material deposition apparatus of claim 1 further comprising an inductive field generator positioned and configured to heat the first deposition material when the first deposition material is in said nozzle and/or after the first deposition material has exited said nozzle.

18. The material deposition apparatus of claim 1 further comprising:
a controller; and
at least one sensor positioned to sense a quality and/or characteristic of the first deposition material after it has exited the nozzle, said controller communicably coupled to receive data of or relating to said at least one sensor and said controller configured to adjust an operating parameter of said material deposition apparatus based upon the received data.

19. The material deposition apparatus of claim 1 further comprising one or more heaters positioned to conductively heat the first deposition material at one or more locations.

20. The material deposition apparatus of claim 1 further comprising a vibrator positioned to communicably impart a vibrational motion to the first deposition material at one or more locations.

21. A material deposition method comprising reciprocating a first plunger at least partially within a first cylinder and toggling a first valve between an open position and closed position with respect to the first cylinder such that when the first valve is toggled to the open position, deposition fluid is allowed to fill the first cylinder as the first piston is being retracted, and subsequently toggling the first valve to a closed position with respect to the first cylinder such that the deposition material no longer flows into the first cylinder, and wherein the deposition material is forced out of the first cylinder as the first piston is advanced within the first cylinder.

22. The method of claim 21 further comprising allowing the deposition material that has been forced out of the first cylinder to flow through a nozzle for deposition.

23. The method of claim 22 further comprising controlling a flow of the deposition material from the first cylinder to the nozzle by selectively toggling a second valve that is in fluid communication between the first cylinder and the nozzle.

24. The material deposition method of claim 22 further comprising reciprocating a second plunger at least partially within a second cylinder and allowing deposition material to fill the second cylinder as the second piston is retracted within the second cylinder; and allowing deposition material to be conveyed from the second cylinder and to flow through a different nozzle.

25. The material deposition method of claim 23 further comprising reciprocating a second plunger at least partially within a second cylinder and allowing deposition material to fill the second cylinder as the second piston is retracted within the second cylinder; and allowing deposition material to be conveyed from the second cylinder and to flow through the nozzle.

26. The material deposition method of claim 25 wherein a stroke of the first piston and a stroke of the second piston are synchronized such that as the first piston is retracted in the first cylinder, the second piston is advanced in the second cylinder.

27. The material deposition method of claim 25 wherein the first valve is coupled to selectively control a flow of the deposition material from a first deposition material container to each of the first cylinder and the second cylinder.

28. The material deposition method of claim 21 further comprising vibrating the first deposition material.

29. The material deposition method of claim 21 further comprising compacting the first deposition material after it has been deposited at a desired application site.

30. The material deposition method of claim 21 further comprising heating the first deposition material.

31. The material deposition method of claim 21 further comprising heating the first deposition material with an inductive heater, wherein the heating occurs while the first deposition material is disposed within a nozzle and/or after the first deposition material has been deposited at an application site.

32. The material deposition method of claim 21 further comprising monitoring a quality and/or characteristic of the first deposition material after it has been deposited at an application site and automatically adjusting an operating parameter of a deposition apparatus in response to the quality and/or characteristic.
